(19) United States
(12) Patent Application Publication
(10) Pub. No.: US 2007/0136697 A1
(43) Pub. Date: Jun. 14, 2007

(54) Mobile terminal apparatus

(75) Inventors: Takeaki Teramae, Yokohama-shi (JP); Yasuke Onishi, Yokohama-shi (JP); Kenji Hasegawa, Yokohama-shi (JP); Motoya Miyauchi, Yokohama-shi (JP)

Correspondence Address: PEARNE & GORDON LLP, 1801 EAST 9TH STREET, SUITE 1200, CLEVELAND, OH, 44114-3108, US

(73) Assignee: Matsushita Electric Industrial Co., Ltd., Kadoma-shi, Osaka (JP)

(21) Appl. No.: 10/578,127

(22) PCT Filed: Nov. 5, 2004
(86) PCT No.: PCT/JP04/16414

§ 371 Date: Jul. 27, 2006

(30) Foreign Application Priority Data
Nov. 6, 2003 (JP) 2003-376661

(51) Int. Cl. G06F 17/00; G08B 5/22

(52) U.S. Cl. 715/977; 715/763; 340/7.56; 340/7.61

(57) ABSTRACT

A mobile terminal apparatus which, in a case where a pictograph exists in an electronic mail, can express mood and feelings in color and pattern corresponding to the pictograph in various manners is provided.

The mobile terminal apparatus includes a wireless receiving/transmitting unit (10) receiving the electronic mail and a pictograph light driving unit (20) which, when the pictograph exists in the electronic mail received by the wireless receiving/transmitting unit (10), drives a pictograph light display portion (19) in a color and pattern registered in advance in a pictograph light registration unit (18) corresponding to the pictograph. Accordingly, when the pictograph exists in the electronic mail, since the pictograph light display portion (19) is displayed in the color and pattern corresponding to the pictograph, it is possible to easily recognize the mood and feelings of the pictograph existing in the electronic mail by the display of the pictograph light display portion (19).

### TECHNICAL FIELD

The present invention relates to a mobile terminal apparatus such as a mobile phone capable of receiving and transmitting an electron mail using a pictograph.

### BACKGROUND ART

Heretofore, a mobile phone has various functions such as an electronic mail and the Internet in addition to a telephone function. Particularly, in the electronic mail, in order to simplify or omit writing a text or express feelings and intimacy to a counter party, suitable pictographs have widely used.

On the other hand, it is well known that, in many electronic mails, contents of the electronic mails are expressed with voices. In addition, it is also well known that, it the pictograph exists in the electronic mail, voices, music, or effect sounds are expressed in separation with a normal text (see, for example, Patent Document 1).

Therefore, it can be determined based on the voices, music, or effect sounds whether or not the pictograph exists in the transmitted electronic mail or the received electronic mail, so that it is very convenient.

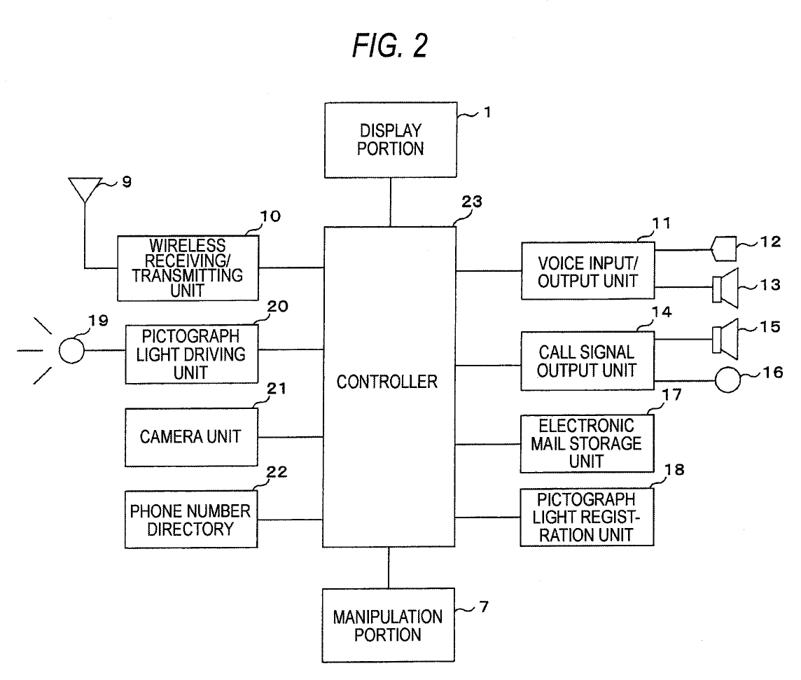

Patent Document 1: JP-A-2003-150507 (Page 2, FIG. 2)

### DISCLOSURE OF THE INVENTION

### PROBLEMS TO BE SOLVED BY THE INVENTION

In the related mobile terminal apparatus, if the pictograph exists during the expression of the content of the electronic mail with voice, the pictograph is expressed with the voices, music, or effect sounds. However, unless the main text of the electronic mail is opened and manipulation for expressing the electronic mail with voice is performed, it is impossible to listen to the voices, music, or effect sounds corresponding to the pictograph.

In addition, the pictograph is represented with the voices, music, or effect sounds, and if the pictograph exists, the voices, music, or effect sounds are directly expressed corresponding to the pictograph. Therefore, when persons are located near, the voices, music, or effect sounds thereof may be unpleasant to the persons. Accordingly, there is a problem in that it is difficult to use the technique in public locations.

The present invention is contrived in consideration of such problems, and the present invention is to provide a mobile terminal apparatus which, in a case where a pictograph exists in an electronic mail, can express mood and feelings in color and pattern corresponding to the pictograph.

Means for Solving the Problems

According an aspect of the present invention, there is provided a mobile terminal apparatus comprising electronic mail receiving means for receiving an electronic mail, and pictograph light driving means for, when a pictograph exists in the electronic mail received by the electronic mail receiving means, driving a pictograph light display portion in a color and pattern registered in advance corresponding to the pictograph.

According to the construction, when the pictograph exists in the electronic mail, since the pictograph light display portion is displayed in the color and pattern corresponding to the pictograph, it is possible to easily recognize the mood and feeling of the pictograph included in the electronic mail through the display of the pictograph light display portion.

In the above aspect of the present invention, the mobile terminal apparatus may further comprise pictograph light registration means for registering a lightening color and pattern in advance corresponding to a pictograph, and determination means for determining whether or not the pictograph received by the electronic mail receiving means is the pictograph registered in advance in the pictograph light registration means, wherein, if the pictograph is the registered pictograph, when the electronic mail including the pictograph is received, the pictograph light display portion is driven by the pictograph light driving means in the color and pattern registered in advance corresponding to the pictograph.

According to the construction, it is determined whether or not the received pictograph is the pictograph registered in advance in the pictograph light registration means, and if the pictograph is the registered pictograph, after the electronic mail including the pictograph is received, the pictograph light display portion is displayed in the color and pattern registered in advance corresponding to the pictograph, so that it is possible to recognize just after the electronic mail is received.

In addition, the mobile terminal apparatus may further comprise light display setting means for setting switching between a state of driving the pictograph light display portion and a state of not driving the pictograph light display portion, wherein, although the pictograph received by the electronic mail receiving means is the pictograph registered in advance in the pictograph light registration means, only if the light display setting means is set to the state of driving the pictograph light display portion, when the pictograph exists in the pictograph received by the electronic mail receiving means, the pictograph light display portion is driven in the color and pattern registered in advance corresponding to the pictograph.

According to the construction, when the pictograph light display portion is set in the non-driven state by the light display setting means, although the pictograph exists in the electronic mail received by the electronic mail receiving means, the pictograph light display portion is not allowed to be driven in the color and pattern corresponding to the pictograph, so that it is possible to drive the pictograph light display portion by suitable changing thereof.

In the above aspect of the present invention, the mobile terminal apparatus may further comprise opening/closing determination means for determining whether a cabinet is in a opened state or in a closed state, and pictograph display stopping means for, in a state that the opening and closing states of the cabinet are determined by the opening/closing determination means, when a predetermined operation is performed, forcibly stopping the display of the pictograph light display portion by the pictograph light driving means.

According to the construction, when a predetermined operation is performed, since the display of the pictograph light display portion by the pictograph light driving means is forcibly stopped, it is possible to prevent a failure of the predetermined operation caused by the display of the pictograph light display portion in advance.

In addition, in a case where the cabinet is determined to be in the opened state by the opening/closing determination means, when the cabinet is charged into the closed state, when switching of a display screen is operated, or when other display competitions occur, the display of the pictograph light display portion by the pictograph light driving means may be forcibly stopped, and in a case where the cabinet is determined to be in the closed state, when a camera key is manipulated, when a memo key is manipulated, or when other display competitions occur, the display of the pictograph light display portion by the pictograph light driving means may be forcibly stopped.

According to the construction, when the cabinet is in the opened stage, by the determination whether or not the cabinet is charged into the closed state, the determination whether or not the switching of a display screen is operated, or determination whether or not other display competitions occur, the display of the pictograph light display portion by the pictograph light driving means may be forcibly stopped. In addition, when the cabinet is in the closed state, by the determination whether or not the camera key is manipulated, the determination whether or not the memo key is manipulated, or the determination whether or not other display competitions occur, the display of the pictograph light display portion by the pictograph light driving means may be forcibly stopped. By doing so, it is possible to prevent failures of these operation caused by the driving of the pictograph light display portion.

In addition, the pictograph light display portion may be a light emitting diode disposed on the cabinet.

According to the construction, it is possible to perform the display by lightening the light emitting diode in the color and pattern corresponding to the pictograph.

In addition, the pictograph light display portion may be a display portion for displaying the electronic mail.

According to the construction, the color and pattern corresponding to the pictograph included in the electronic mail can be displayed by using a portion or the entire of the display portion for display the electronic mail, so that it is possible to perform the display in more various manners.

In addition, the pictograph light display portion may be a sub display portion disposed on the cabinet.

According to the construction, since the sub display portion is disposed on a portion which can be seen even in a case where the cabinet is in the closed state, it is possible to easily recognize the color and pattern corresponding to the pictograph even in a case where the cabinet is in the closed state. Accordingly, it is very useful for receiving the electronic mail.

According another aspect of the present invention, there is provided a mobile terminal apparatus comprising displaying means for displaying an electronic mail list electronic mail selection means for selecting an arbitrary electronic mail from the electronic mail list displayed on the displaying means, and pictograph light driving means for, when a pictograph registered in advance exists in a main text of the electronic mail selected by the electronic mail selection means is displayed, driving a pictograph light display portion in a color and pattern corresponding to the pictograph, wherein, when the electronic mail including the pictograph registered in advance is selected by the electronic mail selection means, the pictograph light display portion is driven in the color and pattern the pictograph by the pictograph light driving means.

According to the construction, the electronic mail list is displayed, and in a case where an arbitrary electronic mail is selected therefrom, if the pictograph registered in advance exists in the electronic mail, the pictograph light display portion is driven in the color and pattern corresponding to the pictograph. Accordingly, for example, without accurately reading the content thereof, it is possible to roughly recognize the mood of the display of the pictograph light display portion. In addition, it is possible to reduce light decoration for the text.

According another aspect of the present invention, there is provided a mobile terminal apparatus comprising displaying means for displaying an electronic mail list electronic mail selection means for selecting one electronic mail from the electronic mail list displayed on the displaying means, changing means for, in a state where a main text of the electronic mail selected by the electronic mail selection means, changing the main text of the displayed electronic mail into a main text of a separate electronic mail, pictograph light driving means for, when the main text of the electronic mail is charged into the main text of the separate electronic mail by the changing means, if a pictograph registered in advance exists in the separate electronic mail after the changing thereof, driving the pictograph light display portion in a color and pattern corresponding to the pictograph.

According to the construction, in a case where the display electronic mail is changed into another electronic mail, if the pictograph registered in advance exists in the changed electronic mail, the pictograph light display portion is displayed in the color and pattern corresponding to the pictograph.

In the above aspect of the present invention, the mobile terminal apparatus may further comprise pictograph light driving means for, in a state where a main text of the electronic mail is displayed, determining whether or not a predetermined pictograph exists in the displayed electronic mail and, if the pictograph exists, driving the pictograph light display portion in a color and pattern corresponding to the pictograph.

According to the construction, even in a case where the main text is displayed on the display portion, by arbitrarily perform the light display manipulation, the display of the color and pattern corresponding to the pictograph in the displayed electronic mail can be performed in the pictograph light display portion, so that it is possible to perform the light display at any time.

According another aspect of the present invention, there is provided a mobile terminal apparatus comprising editing screen displaying means for displaying an editing screen of an electronic mail, electronic mail writing means for, in a state where the editing screen is displayed by the editing screen displaying means, writing the electronic mail, and pictograph light driving means for, when a pictograph registered in advance in pictograph light registration means is used during the writing of the electronic mail by the electronic mail writing means, driving the pictograph light display portion in a color and pattern corresponding to the used pictograph.

According to the construction, when the pictograph registered in the pictograph light registration means is used during the writing of the electronic mail, the pictograph light display portion is displayed in the color and pattern corresponding to the used pictograph, so that it can be recognized.

In addition, every time that the pictograph registered in advance in the pictograph light registration means is used during the writing of the electronic mail, the pictograph light driving means may drive the pictograph light display portion in the color and pattern corresponding to the used pictograph.

According to the construction, every time that the pictograph registered in the pictograph light registration means is used during the writing of the electronic mail, the pictograph light display portion is displayed in the color and pattern corresponding to the used pictograph, so that it can be recognized every time.

In addition, the mobile terminal apparatus may further comprise means for, when the editing screen is terminated during the writing of the electronic mail by the electronic mail writing means, forcibly stopping the display of the pictograph light display portion by the pictograph light driving means.

According to the construction, when the editing screen is terminated during the writing of the electronic mail, the display of the pictograph light display portion by the pictograph light driving means can be forcibly stopped.

In addition, the mobile terminal apparatus may further comprise means for, when a separate event other than the display of the pictograph light display portion by the pictograph light driving means occurs during the writing of the electronic mail by the electronic mail writing means, displaying the separate event on the pictograph light display portion with a priority to the display of the pictograph light display portion by the pictograph light driving means.

According to the construction, when the separate event occurs, the separate event can be display with a priority in the pictograph light display portion. Therefore, for example, when the electronic mail is received, the received electronic mail can be displayed with a priority, sot that it is more used for a user.

According another aspect of the present invention, there is provided a mobile terminal apparatus comprising previewing means for displaying an electronic mail in order to check a content of the electronic mail in advance, wherein, when the electronic mail is displayed by the previewing means, if a pictograph registered in advance exists in the electronic mail, a pictograph light display portion is driven in a color and pattern corresponding to the pictograph.

According to the construction, in a case where the written electronic mail or the to-be-transmitted electronic mail is previewed, if the pictograph registered in advance exists in the previewed electronic mail, the pictograph light display portion is displayed in the color and pattern corresponding to the pictograph.

In the above aspect of the present invention, a plurality of the registered pictographs and the colors and patterns corresponding thereto may be arbitrarily set.

According to the construction, the pictographs stored in the pictograph light storage means and the color and pattern corresponding to the pictographs can be defined arbitrarily and modified in accordance with preference. Therefore, for example, if a rule is made between friends in advance and is used in common to only the friends, the display of the pictograph light display portion is viewed but not recognized by others, so that the display is allowed to be recognized by only the friends.

In addition, the pictograph light driving means may check the content of the electronic mail and, every time that the pictograph registered in advance exists in the electronic mail, drive the pictograph light display portion in the color and pattern corresponding to the checked pictographs in a sequential manner thereof.

According to the construction, every time that the pictograph registered in advance is checked to exist in the electronic mail, the pictograph light display portion can be driven in the color and pattern corresponding to the checked pictographs in a sequential manner thereof, so that it is possible to drive the pictograph light display portion in color and pattern corresponding to the pictograph.

### EFFECT OF THE INVENTION

According to the present invention, it is possible to provide a mobile terminal apparatus which, in a case where a pictograph exists in an electronic mail, can express mood and feelings in color and pattern corresponding to the pictograph in various manners.

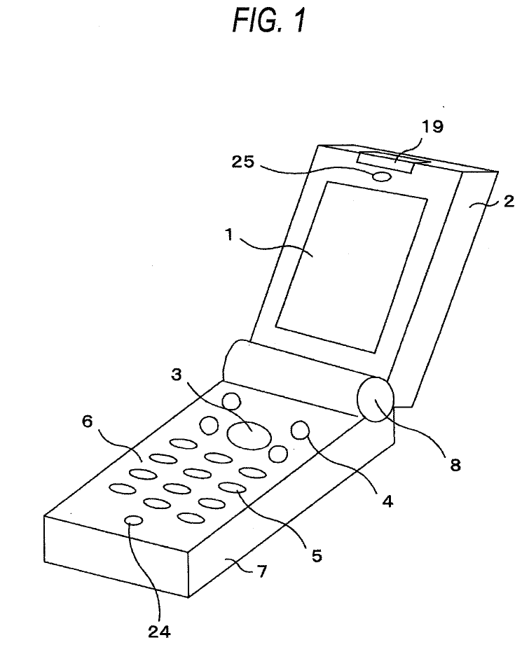

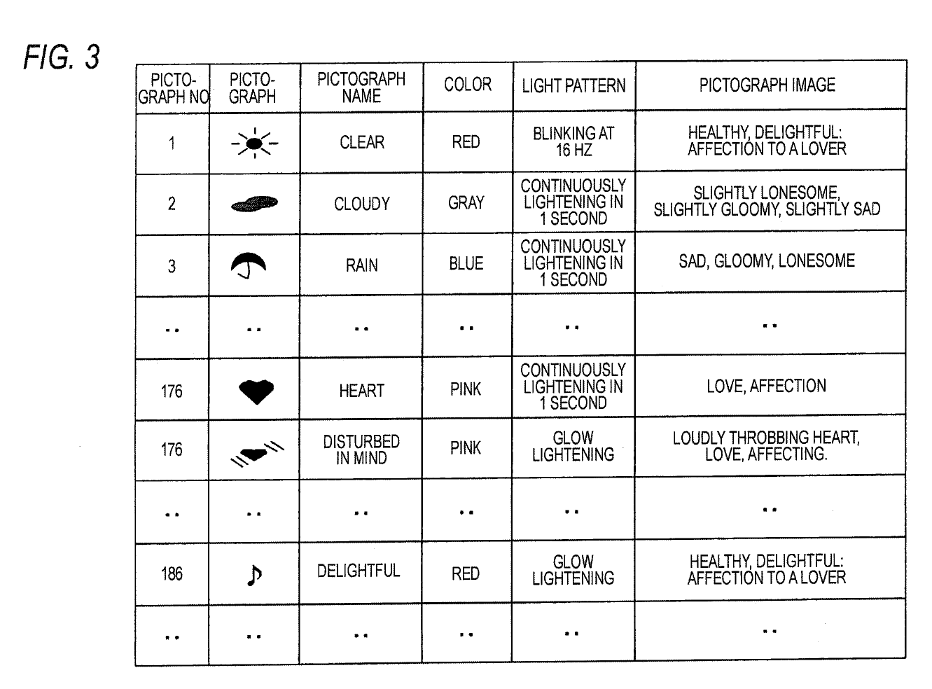

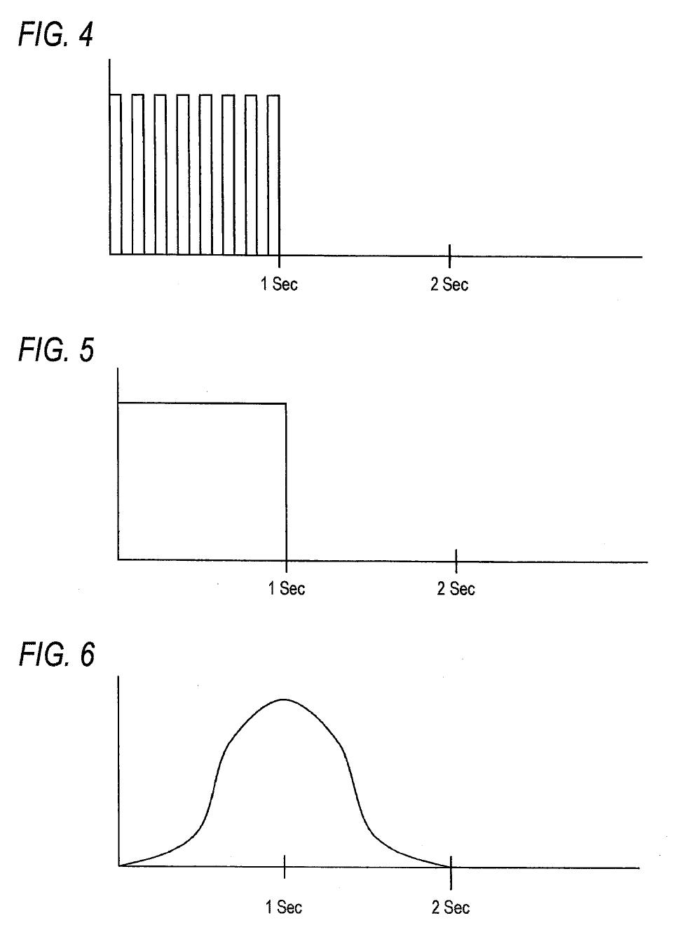

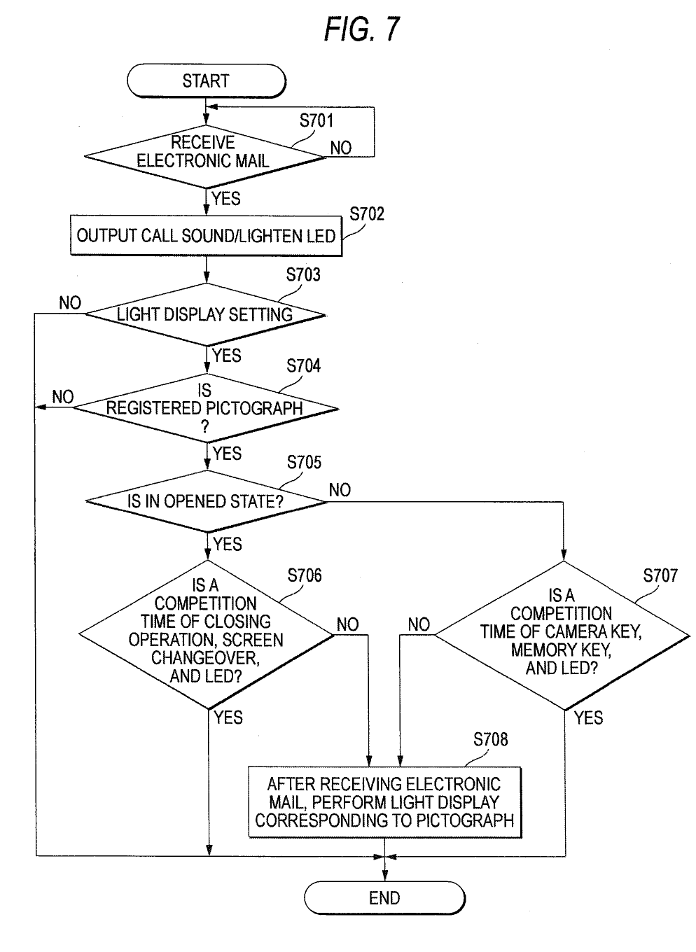

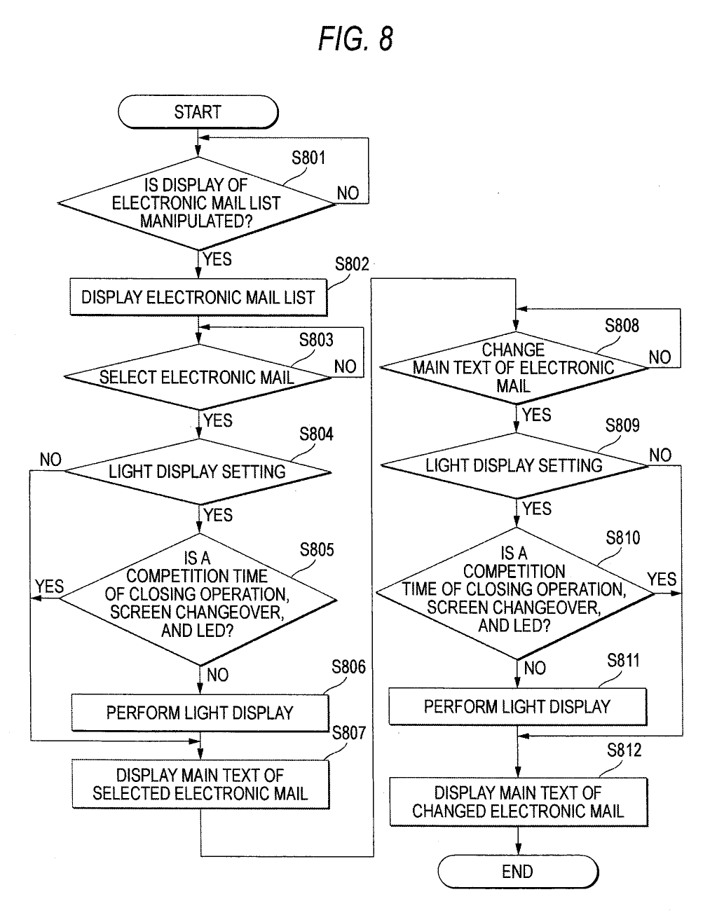

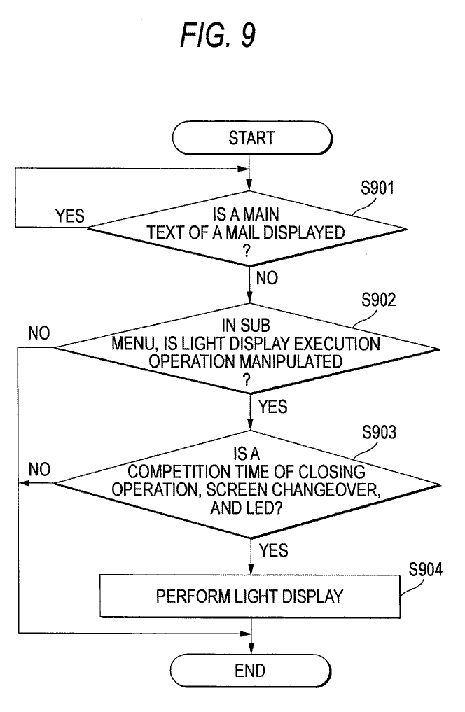

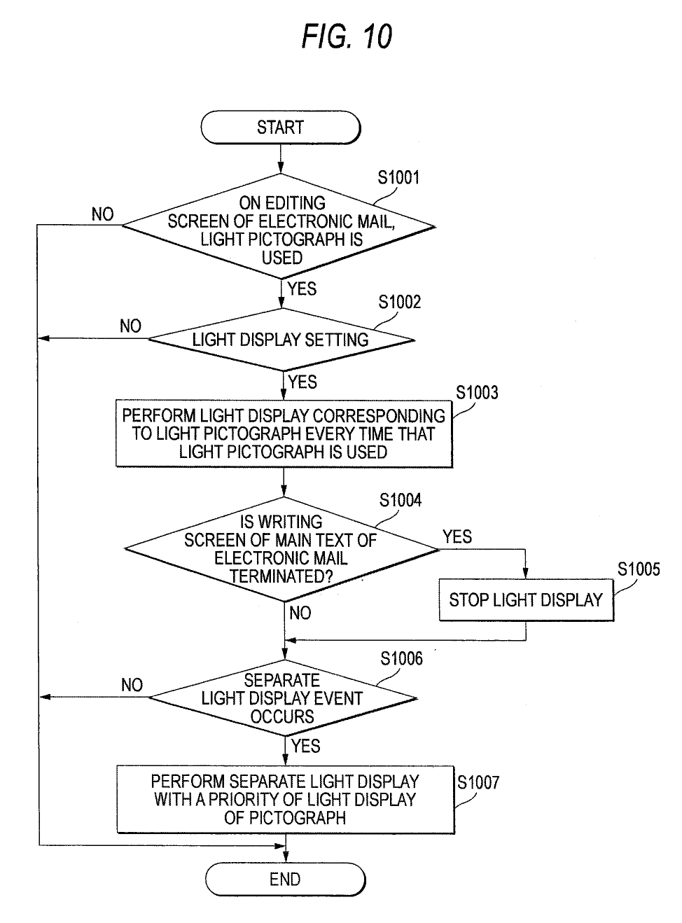

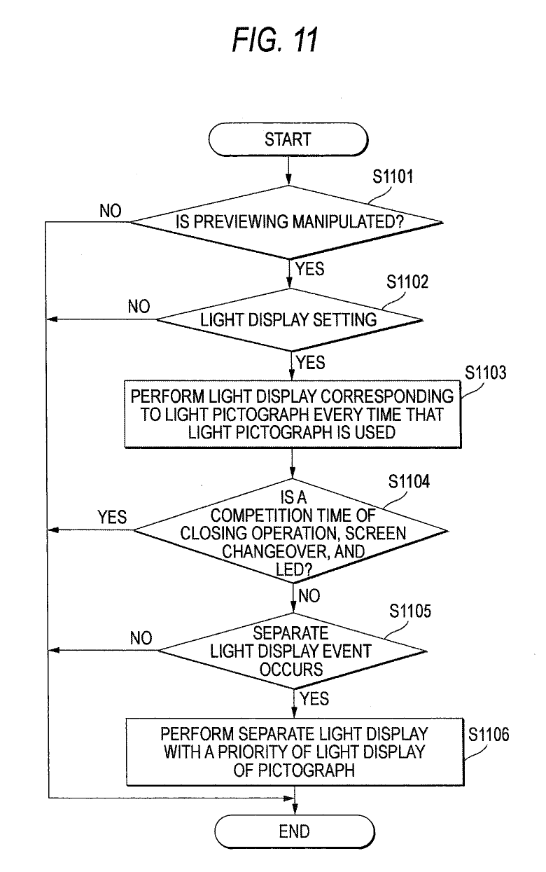

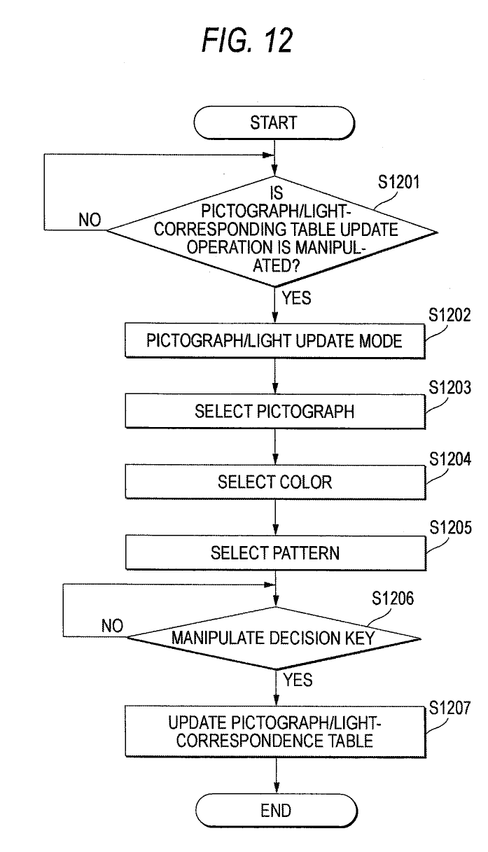

### BRIEF DESCRIPTION OF THE DRAWINGS

[FIG. 1] A view showing an external appearance of a mobile terminal apparatus according to an embodiment of the present invention.

[FIG. 2] A schematic block diagram showing mobile terminal apparatus according to an embodiment of the present invention.

[FIG. 3] A view showing a construction of a pictograph light registration unit used for a mobile terminal apparatus according to an embodiment of the present invention.

[FIG. 4] A view showing a first example of a display pattern of a pictograph light registration unit used for a mobile terminal apparatus according to an embodiment of the present invention.

[FIG. 5] A view showing a second example of a display pattern of a pictograph light registration unit used for a mobile terminal apparatus according to an embodiment of the present invention.

[FIG. 6] A view showing a third example of a display pattern of a pictograph light registration unit used for a mobile terminal apparatus according to an embodiment of the present invention.

[FIG. 7] A flowchart showing operations of an electronic mail receiving time in a mobile terminal apparatus according to an embodiment of the present invention.

[FIG. 8] A flowchart showing operations of an electronic mail opening time in a mobile terminal apparatus according to an embodiment of the present invention.

[FIG. 9] A flowchart showing operations of an electronic mail reading time in a mobile terminal apparatus according to an embodiment of the present invention.

[FIG. 10] A flowchart showing operations of an electronic mail writing time in a mobile terminal apparatus according to an embodiment of the present invention.

[FIG. 11] A flowchart showing operations of an electronic mail previewing time in a mobile terminal apparatus according to an embodiment of the present invention.

[FIG. 12] A flowchart showing operations of a pictograph light-correspondence table updating time in a mobile terminal apparatus according to an embodiment of the present invention.

### DESCRIPTION OF REFERENCE NUMERALS

1 display portion
2 first cabinet
3 navigation key
4 function key
5 number key
6 manipulation portion
7 second cabinet
8 hinge portion
9 antenna
10 wireless receiving/transmitting unit
11 voice input/output unit
12 microphone
13 receiver
14 call signal output unit
15 speaker
16 display portion
17 electronic mail storage unit
18 pictograph light registration unit
19 pictograph light display portion
20 pictograph light driving unit
21 camera unit
22 phone number directory
23 controller

### BEST MODE FOR CARRYING OUT THE INVENTION

Hereinafter, preferred embodiments of the present invention will be described.

FIG. 1 is a view showing an external appearance of a mobile terminal apparatus according to an embodiment of the present invention, and FIG. 2 is a schematic constructional view of the mobile terminal apparatus.

As shown in FIGS. 1 and 2, the mobile terminal apparatus according to an embodiment of the present invention includes a first cabinet 2 having a display portion 1, a second cabinet 7 having a manipulation portion 6 including various manipulation keys such as a navigation key 3, function keys 4, and number keys 5, wherein the cabinets 2 and 7 are connected to each other with a hinge portion 8 and constructed to be closed and closed with the hinge portion 8 centered.

As shown in FIG. 2, in addition to the display portion 1 and the manipulation portion 6, the cabinets 2 and 7 are embedded with a wireless receiving/transmitting unit 10 connected to an antenna 9, a voice input/output unit 11, a microphone 12 and a receiver 13 which are connected to the voice input/output unit 11, a call signal output unit 14, a speaker 15 connected to the call signal output unit 14 to output a call sound, a call display portion 16, an electronic mail storage unit 17 for storing received and transmitted electronic mails, a pictograph light registration unit 18 for storing pictographs colors used in the electronic mails, patterns, or like corresponding the pictographs, a pictograph light driving unit 20 which determines whether or not the pictograph used in the electronic mail is registered in the pictograph light registration unit 18 and, if registered, drives a pictograph light display portion 19, a camera unit 21, a phone number directory 22, and a controller 23 for controlling these components.

In addition, the microphone 12 and the receiver 13 are disposed at positions corresponding to a sound collecting hole 24 formed on the second cabinet 7 and a sound releasing hole 25 formed on the first cabinet 2, respectively. In addition, the speaker 15 is disposed on a rear surface (not shown) of the first or second cabinet 2 or 4 at position opposite to the sound releasing hole 25. In addition, a camera constituting the camera unit 21 has a lens unit (not shown) which is disposed on the rear surface of the first cabinet 2 so as to be exposed.

In addition, the display portion 1 includes a main display portion which is disposed on a front surface of the first cabinet 2 and a display portion (not shown) (hereinafter, referred to as a sub display portion) which is disposed on a rear surface of the first cabinet 2 and has a smaller size that the main display portion. The main display portion is constructed to display various information in a state that the first and second cabinets 2 and 7 are opened, and the sub display portion is constructed to display time, a phone number and a name of a caller when there is a call, or other various required information in a state that the first and second cabinets 2 and 7 are closed.

In addition, as shown in FIG. 3, in the pictograph light registration unit 18, pictograph numbers (ID), names thereof, to-be-lightened colors and pattern, and the like corresponding to the pictographs used for the electronic mail are stored and registered as a table.

As shown in FIG. 3, although pictographs of, for example, icons are stored and registered in the table, pictographs (for example, “⋆” representing a star) which are formed with one character constructed by allocating ASCII code or JIS code to a character code or pictographs (for example, “:D” or “(\hat{0}_\hat{0})” representing pleasure) which are formed with a series of plural characters to representing humane feelings by imitating a face of a human may be stored and registered. In addition, pictographs showing animation motion may be stored and registered.

In addition, still images (pictures) picked up with the camera unit 21 or still images (pictures) received through the wireless receiving/transmitting unit 10 are stored in a temporary storage unit (not shown) or a storage unit, and after that, a processing for changing image sizes or image formats of these images in a pickup image processing unit (not shown) is performed, so that the stored ones stored as pictographs maybe stored and registered in a table.

Alternatively, a set of moving images or sequentially-picked-up still images (pictures) picked up with the camera unit 21 or a set of moving images or sequentially-picked-up still images (pictures) received through the wireless receiving/transmitting unit 10 is stored in a temporary storage unit (not shown) or a storage unit, and after that, a processing for changing image sizes or image formats of these images in a pickup image processing unit (not shown) is performed, so that the stored ones as pictographs representing animation motion maybe stored and registered in a table. In addition, new pictographs received through the wireless receiving/transmitting unit 10 may be stored and registered.

Here, as shown in FIGS. 4 to 6, “to-be-lightening pattern” may include, for example, a 16 Hz blinking pattern which repeats blinking with a predetermined frequency of 16 Hz, a continuously lightening pattern which lightens continuously in one second, a glow lightening pattern which reaches to a maximum light amount in one second and then returns to an initial state in one second, or other patterns. In addition, it should be noted that the “pictograph” is limited to pictures representing characters but it is collectively used to include, for example, designs or images for parodying face pictures, face shapes, or face expression, words, a series of-characters, a text, or others for representing feelings.

Next, operations of the mobile terminal apparatus according to an embodiment of the present invention will be described in detail.

Firstly, in the mobile terminal apparatus according to the embodiment of the present invention, the first and second cabinets 2 and 7 are allowed to be opened and closed with the hinge portion 8. In a state that the first and second cabinets 2 and 7 are opened from each other, by performing a predetermined operation using the manipulation portion 6, electronic mails or calls can be transmitted, sent, received, and delivered.

In case of sending a call, by inputting a phone number of a counter party through number keys 6 or by retrieving a phone number of a counter party from a phone number directory 22 through manipulation of predetermined manipulation keys, once displaying the phone number on the display portion 1, and manipulating predetermined sending keys, the phone number input through the number keys 5 or the phone number retrieved from the phone number directory 22 can be transmitted through the wireless receiving/transmitting unit 10 to a telephone base station (not shown), so that the call can be sent. When the counter party responds to the sent call, a communication circuit is formed between the caller and the counter party through the wireless receiving/transmitting unit 10, and communication can be made between the caller and the counter party through the voice input/output unit 11 and the wireless receiving/transmitting unit 10 by using the microphone 12 and the speaker 13.

When a phone call from a counter party is received through the wireless receiving/transmitting unit 10, a predetermined call signal is output from a call sound output portion 14 to the speaker 15 under the control of the controller 23, the predetermined call sound is output from the speaker, and the call display portion 16 is also lightened in a predetermined pattern. Although not shown, if the call sound output portion 14 is connected to a call vibrator, the vibrator is set to be vibrate, so that the phone call from the counter party can be informed by using the vibration of the vibrator. In response to the phone call, by manipulating a predetermined key, communication can be made between the caller and the counter party.

Similarly, in case of transmitting the electronic mail, by writing an electronic mail with the navigation key 3, the function keys, the number keys 5, or the like, retrieving an electronic mail address of a counter party from the phone number directory 22 or inputting the electronic mail address with the number keys 5, once displaying the electronic mail address on the display portion 1, and manipulating a transmitting key in the state, the electronic mail, written by using the navigation key 3, the function keys, the number keys 5, or the like together with the electronic mail address input by using the number keys 5 or retrieved from the phone number directory 18, is transmitted through the wireless receiving/transmitting unit 10 to a provider (not shown), so that the electronic mail can be transmitted to the counter party.

The electronic mail from the counter party is automatically received by the wireless receiving/transmitting unit 10 and automatically stored in an electronic mail storage unit 17 under the control of the controller 23. The stored electronic mail can be arbitrarily taken out from the electronic mail storage unit 17 by using the manipulation portion 6, so that the electronic mail can be easily checked through display of the display unit 1.

In the mobile terminal apparatus according to the embodiment, as shown in FIG. 3, pictographs used for the electronic mail and colors and pattern corresponding to the pictographs are registered in the pictograph light registration unit 18. At a time that the electronic mail is received, a time that the electronic mail list is displayed and one of them is selected, a time that the displayed electronic mail is changed into a separate electronic mail, or a time that the pictographs are arbitrarily displayed on the electronic mail, the pictograph light display portion is designed to be displayed with colors and patterns corresponding to the pictographs.

Hereinafter, the description thereof will be made more in detail with reference to flowcharts shown in FIGS. 7 to 11.

(Electronic Mail Receiving Time)

As shown in FIG. 7, when the wireless receiving/transmitting unit 10 receives the electronic mail through the antenna 9 (Yes in S701), under the control of the controller 23, a predetermined call signal is output through the call signal output unit 14, a predetermined call sound is output from the speaker 15, and a predetermined pattern is displayed on the display portion 16 (S702).

In a case where a pictograph exists in the received electronic mail, if light display setting indicating that the pictograph intends to be displayed on the pictograph light display portion 19 in a predetermined color or pattern is made in advance by using the manipulation portion 6 (Yes in S703), the controller 23 checks for the pictograph light registration unit 18 and determines whether or not a pictograph registered in the pictograph light registration unit 18 exists in the received electronic mail (S704).

If the light display setting is not made (No in S703) or if a pictograph registered in the pictograph light registration unit 18 does not in the received electronic mail (No in S704), the associated operation ends, and the received electronic mail is stored in the electronic mail storage unit 17.

If the light display setting is made (Yes in S703) and if a pictograph registered in the pictograph light registration unit 18 exists in the received electronic mail (Yes in S704), it is determined whether or not the first and second cabinets 2 and 7 are in an opened state or in a closed state (S705). If the cabinets are in the opened state, it is determined whether or not an operation for the closed state is made, whether or not there is screen changeover such as screen switching, or whether or not interruption required for allowing the display portion 16 to be operated in a separate operation is made (S706). If the cabinets are in the closed state (Yes in S705), it is determined whether or not camera manipulation is made, whether or not a menu key is manipulated, or whether or not interruption required for allowing the display portion 16 to be operated in a separate operation is made (S707).

As a result of the determination, if there is the interruption (Yes in S607 or Yes in S707), under the control of the controller 23, the pictograph light display portion 19 is not displayed. If there is not the interruption (No in S607 or No in S707), under the control of the controller 23, the pictograph detection driving unit 20 is operated to display the pictograph light display portion 19 in a predetermined color and pattern corresponding to the pictograph in the received electronic mail (S708).

In this manner, according to the embodiment, when the electronic mail is received, if the pictograph exists in the electronic mail, the pictograph light display portion 19 can be displayed in the color and pattern corresponding to the pictograph. In addition, according to the first and second cabinets 2 and 7 are in the opened state or in the closed state, it is determined whether or not the interruption is made. If the interruption is made, since the interruption has priority, unnecessary display cannot be performed in a case of the interruption is made.

In addition, in the embodiment, when the electronic mail is received, although the call sound is firstly output and, after that, it is determined whether or not the pictograph light display portion 19 is driven, it may be firstly determined whether or not the pictograph light display portion 19 is driven and, after that, the call sound may be output. In other words, in the embodiment, an order of determinations of the controllers is not limited to the order shown in FIG. 7, but other orders may be used.

(Electronic Mail Opening Time)

As shown in FIG. 8, in a state that previously received or transmitted electronic mails are stored in the electronic mail storage unit 17, a manipulation for performing electronic mail list display is performed by using the manipulation portion 6 (Yes in S801), an electronic mail list is display on the display portion (S802).

With respect to the electronic mail list, by manipulating of the manipulation portion 6, the received electronic mails or the transmitted electronic mails may be individually displayed in a time sequence manner or in a counter party sorting manner, or a group of the received electronic mails and the transmitted electronic mails may be displayed in a time sequence manner or in a counter party sorting manner. As a result, the electronic mail list is displayed on the display portion 1.

In a state that the electronic mail list is displayed on the display portion 1, an arbitrary electronic mail is selected among the displayed electronic mails by using the manipulation portion 6 (S803). Next, if the pictograph exists in the electronic mail, the controller 23 determines whether or not the light display setting indicating that the pictograph intends to be displayed on the pictograph light display portion 19 in a predetermined color or pattern is made in advance by using the manipulation 6 (S804). If the light display setting is determined to be made (Yes in S804), it is determined whether or not an operation for the closed state is made, whether or not there is screen changeover such as screen switching, or whether or not interruption required for allowing the display portion 16 to be operated in a separate operation is made (S805).

If there is not determined to be the interruption, it is determined whether or not a pictograph registered in the pictograph light registration unit 18 exists in the selected electronic mail. If the pictograph exist, the pictograph detection driving unit 20 is driven to drive the pictograph light display portion 19 in a predetermined color and pattern registered in the pictograph light registration unit 18, so that the light display is performed (S806). At the same time or after the light display is performed, a main text of the selected electronic mail is displayed on the display portion 1 (S807).

If the light display setting is not made (No in S804) or in a case where, although the light display setting is made, the interruption is made (Yes in S805), the display portion 19 is not displayed with the color and pattern registered in the pictograph light registration unit 18, and the selected electronic mail is displayed on the display portion 1 (S807).

In a state that the main text of the electronic mail is displayed on the display portion 1 (S807), when a change operation for allowing the main text of the electronic mail to be in the former electronic mail or the later electronic mail is performed (Yes in S808), similar to the aforementioned case, if there is a pictograph in the electronic mail (the former electronic mail or the latter electronic mail to be displayed on the display portion 1), it is determined whether or not an operation indicating that the pictograph intends to be displayed on the pictograph light display portion 19 in a predetermined color or pattern is performed in advance by using the manipulation portion 6 (whether or not the light display setting is made) (S809). If the light display setting is made in advance (Yes S809), it is determined whether or not an operation for the closed state is made, whether or not there is screen changeover such as screen switching, or whether or not interruption required for allowing the display portion 16 to be operated in a separate operation is made (S810).

If there is not determined to be the interruption, it is determined whether or not a pictograph registered in the pictograph light registration unit 18 exists in the switched electronic mail. If the pictograph exist, the pictograph detection driving unit 20 is driven to drive the pictograph light display portion 19 in a predetermined color and pattern registered in the pictograph light registration unit 18, so that the light display is performed (S811) At the same time or after the light display is performed, a main text of the selected electronic mail is displayed on the display portion 1 (S812).

If the light display setting is not made (No in S809) or in a case where, although the light display setting is made, the interruption is made (Yes in S810), the display portion 19 is not displayed with the color and pattern registered in the pictograph light registration unit 18, and the selected electronic mail is displayed on the display portion 1 (S812).

In this manner, according to the embodiment, the electronic mail is displayed, and when an arbitrary electronic mail is selected and displayed among the list and, in a state that the arbitrary electronic mail is displayed, when the electronic mail is switched to a separate electronic mail, it is determined whether or not the pictograph registered in the pictograph light registration unit 18 exists in the electronic mail. If the pictograph exists, the pictograph light display portion 19 can be displayed in the color and pattern registered in the pictograph light registration unit 18 corresponding to the pictograph. Accordingly, every time that the electronic mail is displayed, the pictograph light display portion 19 can be displayed corresponding to the pictograph existing in the electronic mail.

(Electronic Mail Reading Time)

In a state that the main text of the electronic mail is displayed, it is determined whether or not the pictograph registered in the pictograph light registration unit 18 exists in the displayed electronic mail by using the manipulation portion 6 or a sub menu. If the pictograph exist, in a case where an operation (light display execution operation) indicating that the pictograph intends to be displayed on the pictograph light display portion 19 in a predetermined color or pattern is performed by using the manipulation portion 6, as shown in FIG. 9, in a state (Yes in S901) that the main text of the electronic mail is displayed on the display portion 1, it is determined whether or not the light display execution operation is performed by using the manipulation portion 6 or the sub menu (S902).

In the light display execution operation is determined to be performed (Yes in S902), it is determined whether or not an operation for the closed state is made, whether or not there is screen changeover such as screen switching, or whether or not interruption required for allowing the display portion 16 to be operated in a separate operation is made (S903). If there is not determined to be the interruption, it is determined whether or not a pictograph registered in the pictograph light registration unit 18 exists in the displayed electronic mail. If the pictograph exist, the pictograph detection driving unit 20 is driven to drive the pictograph light display portion 19 in a predetermined color and pattern registered in the pictograph light registration unit 18, so that the so-called light display is performed (S904).

If light display execution operation is not performed (No in S902) or in a case where, although the light display execution operation is performed, the interruption is made (Yes in S902), the display portion 19 is not displayed with the color and pattern registered in the pictograph light registration unit 18, a series of operations ends, and the displayed electronic mail is continuously displayed on the display portion 1.

In this manner, according to the embodiment, in a state that an arbitrary electronic mail is displayed, if a light display execution operation indicating that the light display intends to be performed is performed, it is determined whether or not the pictograph registered in the pictograph light registration unit 18 exists in the displayed electronic mail. If the pictograph registered in the pictograph light registration unit 18 exist, the pictograph light display portion 19 can be displayed in the color and pattern registered in the pictograph light display portion 19 corresponding to the pictograph. Accordingly, every time that the electronic mail is displayed, it can be checked whether or not the pictograph registered in the pictograph light registration unit 18 exists in the electronic mail, and the pictograph light display portion 19 can be displayed at any time.

(Electronic Mail Writing Time)

In a state a screen (hereinafter, an editing screen) for writing or editing the electronic mail by using the manipulation portion 6 is displayed on the display portion 1, in a case where the electronic mail is written in the state, the associated operation are shown in FIG. 10.

More specifically, in the editing screen, if the pictograph (hereinafter, referred to as a light pictograph) registered in the pictograph light registration unit 18 is used (Yes in S1001), the use of the pictograph is determined by using the pictograph light registration unit 18 under the control of the controller 23. It is determined whether or not an operation for allowing the pictograph light display portion 19 to be displayed in a predetermined color and pattern corresponding to the pictograph is set in advance in the manipulation portion 6 (namely, whether or not the light display setting is made) (S1002). If the light display setting is made (Yes in S1002), every time that the light pictograph is used, the controller 23 takes out information on the color and pattern corresponding to the light pictograph from the pictograph light registration unit 18, and the light display is performed on the pictograph light display portion 19 in the color and pattern corresponding to the light pictograph (S1003).

In a case where the editing screen is terminated by using the manipulation portion 6 (Yes in S1004), the light display is stopped (S1005). In a case where, irrespective of the termination of the editing screen, a separate light display event, for example, an event that, in receipt of an electronic mail, the light display for the received electronic mail must be performed occurs (Yes in S1006), the separate light display is performed prior to the light display for the light pictograph (S1007).

In this manner, according to the embodiment, in a case where the pictograph registered in the pictograph light registration unit 18 is used during the writing or editing time for the electronic mail, the pictograph light display portion 19 can be displayed in the color or pattern registered in the pictograph light registration portion 18 every time that the pictograph is used. When the editing screen is terminated, the display is stopped, and if a separate display is required, the separate display can be displayed with a priority.

(Electronic Mail Previewing Time)

In a case where the written electronic mail is previewed, the operations shown in FIG. 11 are performed.

In a state where the written electronic mail is previewed by using the manipulation portion 6, the controller 23 detects the manipulation (Yes in S1101). If the pictograph registered in the pictograph light registration unit 18 exists in the previewed electronic mail, it is determined under the control of the controller 23 whether or not an operation for allowing the pictograph light display portion 19 to be displayed in a predetermined color and pattern corresponding to the pictograph is set in advance in the manipulation portion 6 (namely, whether or not the light display setting is made) (S1102). If the light display setting is made (Yes in S1002), every time that the pictograph registered in the pictograph light registration unit 18 exists, the display is performed on the pictograph light display portion 19 in the color and pattern corresponding to the light pictograph (S1103).

After that, it is determined whether or not an operation for the closed state is made, whether or not there is screen changeover such as screen switching, or whether or not interruption required for allowing the display portion 16 to be operated in a separate operation is made (S1104). If there is the interruption, a series of operations ends. If there is no interruption, it is determined whether or not a separate light display event, for example, an event that, in receipt of an electronic mail, the light display for the received electronic mail must be performed occurs (S1105). If the separate light display event occurs (Yes in S1105), the separate display is performed with a priority (S1006).

In this manner, according to the embodiment, in a case where the electronic mail is previewed, if the pictograph registered in the pictograph light registration unit 18 exists in the previewed electronic mail, the pictograph light display portion 19 is displayed in the color or pattern registered in the pictograph light registration portion 18 corresponding to the pictograph. In addition, if there is interruption, or if an event requiring a separate light display occurs, during the previewing time, the interruption or the separate event can be performed with a priority, so that it is practically useful.

(Update of Pictograph Light Registration Unit)

In addition, in the embodiment, a pictograph light-correspondence table stored in the pictograph light registration unit 18 is designed to be arbitrarily modified and updated.

FIG. 12 is a flowchart showing operations of arbitrarily modifying and updating the pictograph light-correspondence table stored in the pictograph light registration unit 18.

If an operation for modifying and updating the pictograph light-correspondence table stored in the pictograph light registration unit 18 by using the manipulation portion 6 is performed (Yes in S1201), the controller 23 detects the operation, so that an update mode of the pictograph light-correspondence table proceeds (S1202). In the update mode, a pictograph is selected (S1203), a color is selected (S1204), and a pattern is selected (S1205). In this state, if a predetermined decision key is manipulated (Yes in S1206), the color and pattern corresponding to the previously selected pictograph are rewritten and updated with the selected color and pattern (S1207).

In addition, if the pictographs, the colors, and the patterns are constructed to be allowed to be arbitrarily rewritten, a variety of pictographs, colors and patterns can be registered in correspondence thereto.

According to the aforementioned embodiment, during the receiving, opening, writing, editing, or previewing time of the electronic mail, the pictograph light registration unit 18 is checked at the timings thereof. If the pictograph registered in the pictograph light registration unit 18 exist in the electronic mail, the pictograph light display portion 19 is constructed to be displayed in the color or pattern registered in the pictograph light registration portion 18 corresponding to the pictograph. Since the pictograph light display portion 19 is displayed in the previously registered color and pattern, if the color and pattern are combined with the mood or feelings of the user or the counter party, it is possible to recognize the mood or feelings of the counter party through the display of the pictograph light display portion 19 before or during the viewing of the electronic mail. Accordingly, a variety of feeling can be expressed.

In addition, in the embodiment, although the call display portion 16 and the pictograph light display portion 19 are separately provided, a combination thereof can be used.

In addition, although the pictograph light display portion 19 is provided to one end portion of the first cabinet 2 in separation with the display portion 1, a portion or the entire of the display portion 1 may be used the pictograph light display portion 19. Namely, with respect to the pictograph light display portion 19, in the main display portion constituting the display portion 1, a backlight or background thereof may be used for the pictograph light display portion, or the pictograph itself or a portion thereof may be used for pictograph light display portion. Similarly, in sub display portion, the backlight or background thereof may be used for the pictograph light display portion, or the pictograph itself or a portion thereof may be used for pictograph light display portion. According to the construction, it is possible to easily see the pictograph light display portion during the viewing of the electronic mail.

In addition, in the embodiment, the pictograph and the color and pattern corresponding to the pictograph are registered in the pictograph light registration unit 18, and the pictograph light display portion 19 is displayed in the color or pattern registered in the pictograph light registration portion 18. However, in addition to the pictograph light registration unit 18, registration means for registering a melody corresponding to the pictograph or vibration means for vibrating with different strengths or patterns corresponding to the pictographs may be provided in a separate manner or a combination manner. In addition to the display of the pictograph light display portion in the color and pattern corresponding to the pictograph, the melody corresponding to the pictograph may be output from the speaker 15, or a portion or the entire of the mobile terminal apparatus may be vibrated with the strength or the pattern corresponding to the pictograph.

According to the construction, the mood and feelings of the counter party can be expressed with the melody and vibration as well as the light, so that it is possible to express the mood and feelings in more various manners. In addition, the vibration means for vibrating with different strengths or patterns corresponding to the pictographs may be provided separately irrespective of the pictograph light registration unit 18. In this case, since the light is not be used, it is possible to recognize the mood and feelings of the counter party without being detected by others.

While the present invention has been described with reference to exemplary and particular embodiments thereof, it will be understood by those skilled in the art that various changes in form and details may be made therein without departing from the spirit and scope of the invention as defined by the appended claims.

This application claims the benefit of Japanese Patent Application No. 2003-376661, filed on Nov. 6, 2003, the disclosure of which is incorporated herein in its entirety by reference.

### INDUSTRIAL USABILITY

A mobile terminal apparatus according to the present invention has advantages in that, when a pictograph exists in an electronic mail, mood or feelings corresponding to the pictograph can be expressed in a color and pattern, and it is useful for the mobile terminal apparatus.

1. A mobile terminal apparatus comprising:
an electronic mail receiving unit which receives an electronic mail; and
a pictograph light driving unit which, when a pictograph exists in the electronic mail received by the electronic mail receiving unit drives, a pictograph light display portion in a color and pattern registered in advance corresponding to the pictograph.

2. The mobile terminal apparatus according to claim 1, further comprising:
a pictograph light registration unit which registers a lightening color and pattern in advance corresponding to a pictograph; and
a determination unit which determines whether or not the pictograph received by the electronic mail receiving unit is the pictograph registered in advance in the pictograph light registration unit,
wherein, if the pictograph is the registered pictograph, when the electronic mail including the pictograph is received, the pictograph light display portion is driven by the pictograph light driving unit in the color and pattern registered in advance corresponding to the pictograph.

3. The mobile terminal apparatus according to claim 1, further comprising:
a light display setting unit which sets switching between a state of driving the pictograph light display portion and a state of not driving the pictograph light display portion,
wherein, although the pictograph received by the electronic mail receiving unit is the pictograph registered in advance in the pictograph light registration unit, only if the light display setting unit is set to the state of driving the pictograph light display portion, when the pictograph exists in the pictograph received by the electronic mail receiving unit, the pictograph light display portion is driven in the color and pattern registered in advance corresponding to the pictograph.

4. The mobile terminal apparatus according to claim 1, further comprising: an opening/closing determination unit which determines whether a cabinet is in a opened state or in a closed state; and
a pictograph display stopping unit which, in a state that the opening and closing states of the cover are determined by the opening/closing determination unit, when a predetermined operation is performed, forcibly stopping the display of the pictograph light display portion by the pictograph light driving unit.

5. The mobile terminal apparatus according to claim 4,
wherein, in a case where the cabinet is determined to be in the opened state by the opening/closing determination unit, when the cover is charged into the closed state, when switching of a display screen is operated, or when other display competitions occur, the display of the pictograph light display portion by the pictograph light driving unit is forcibly stopped, and
wherein, in a case where the cabinet is determined to be in the closed state, when a camera key is manipulated, when a memo key is manipulated, or when other display competitions occur, the display of the pictograph light display portion by the pictograph light driving unit is forcibly stopped.

6. The mobile terminal apparatus according to claim 1, wherein the pictograph light display portion is a light emitting diode disposed on the cabinet.

7. The mobile terminal apparatus according to claim 1, wherein the pictograph light display portion is a display portion for displaying the electronic mail.

8. The mobile terminal apparatus according to claim 1, wherein the pictograph light display portion is a sub display portion disposed on the cabinet.

9. A mobile terminal apparatus comprising:
a displaying means unit which displays an electronic mail list;
an electronic mail selection unit which selects an arbitrary electronic mail from the electronic mail list displayed on the displaying unit; and
pictograph light driving unit which, when a pictograph registered in advance exists in a main text of the electronic mail selected by the electronic mail selection unit, drives a pictograph light display portion in a color and pattern corresponding to the pictograph,
wherein, when the electronic mail including the pictograph registered in advance is selected by the electronic mail selection unit, the pictograph light display portion is driven in the color and pattern the pictograph by the pictograph light driving unit.

10. A mobile terminal apparatus comprising:
a displaying unit which displays an electronic mail list;
an electronic mail selection unit which selects one electronic mail from the electronic mail list displayed on the displaying unit;
a changing unit which, in a state where a main text of the electronic mail selected by the electronic mail selection unit is displayed, changing the main text of the displayed electronic mail into a main text of a separate electronic mail;
a pictograph light driving unit which, when the main text of the electronic mail is changed into the main text of the separate electronic mail by the changing unit, if a pictograph registered in advance exists in the separate electronic mail after the changing thereof, drives the pictograph light display portion in a color and pattern corresponding to the pictograph.

11. The mobile terminal apparatus according to claim 10, further comprising:
a pictograph light driving unit which, in a state where a main text of the electronic mail is displayed, determines whether or not a predetermined pictograph exists in the displayed electronic mail and, if the pictograph exists, drives the pictograph light display portion in a color and pattern corresponding to the pictograph.

12. A mobile terminal apparatus comprising:
an editing screen displaying unit which displays an editing screen of an electronic mail;
an electronic mail writing unit which, in a state where the editing screen is displayed by the editing screen displaying unit, writes the electronic mail; and
a pictograph light driving unit which, when a pictograph registered in advance in a pictograph light registration unit is used during the wiring of the electronic mail by the electronic mail writings unit, drives the pictograph light display portion in a color and pattern corresponding to the used pictograph.

13. The mobile terminal apparatus according to claim 12, wherein, every time that the pictograph registered in advance in the pictograph light registrations unit is used during the wiring of the electronic mail, the pictograph light driving unit drives the pictograph light display portion in the color and pattern corresponding to the used pictograph.

14. The mobile terminal apparatus according to claim 12, further comprising:
means for, when the editing screen is terminated during the writing of the electronic mail by the electronic mail writings unit, forcibly stopping the display of the pictograph light display portion by the pictograph light driving unit.

15. The mobile terminal apparatus according to claim 12, further comprising:
means for, when a separate event other than the display of the pictograph light display portion by the pictograph light driving unit occurs during the writing of the electronic mail by the electronic mail writing unit, displaying the separate event on the pictograph light display portion with a priority to the driving of the pictograph light display portion by the pictograph light driving unit.

16. A mobile terminal apparatus comprising:
a previewing unit which displays an electronic mail in order to check a content of the electronic mail in advance,
wherein, when the electronic mail is displayed by the previewing unit, if a pictograph registered in advance exists in the electronic mail, a pictograph light display portion is driven in a color and pattern corresponding to the pictograph.

17. The mobile terminal apparatus according to claim 1, wherein a plurality of the registered pictographs and the colors and patterns corresponding thereto are arbitrarily set.

18. The mobile terminal apparatus according to claim 1, wherein the pictograph light driving unit checks the content of the electronic mail and, every time that the pictograph registered in advance exists in the electronic mail, drives the pictograph light display portion in the color and pattern corresponding to the checked pictographs in a sequential manner thereof.

19. The mobile terminal apparatus according to claim 9, wherein a plurality of the registered pictographs and the colors and patterns corresponding thereto are arbitrarily set.

20. The mobile terminal apparatus according to claim 9, wherein the pictograph light driving unit checks the content of the electronic mail and, every time that the pictograph registered in advance exists in the electronic mail, drives the pictograph light display portion in the color and pattern corresponding to the checked pictographs in a sequential manner thereof.

21. The mobile terminal apparatus according to claim 10, wherein a plurality of the registered pictographs and the colors and patterns corresponding thereto are arbitrarily set.

22. The mobile terminal apparatus according to claim 10, wherein the pictograph light driving unit checks the content of the electronic mail and, every time that the pictograph registered in advance exists in the electronic mail, drives the pictograph light display portion in the color and pattern corresponding to the checked pictographs in a sequential manner thereof.

23. The mobile terminal apparatus according to claim 12, wherein a plurality of the registered pictographs and the colors and patterns corresponding thereto are arbitrarily set.

24. The mobile terminal apparatus according to claim 12, wherein the pictograph light driving means checks the content of the electronic mail and, every time that the pictograph registered in advance exists in the electronic mail, drives the pictograph light display portion in the color and pattern corresponding to the checked pictographs in a sequential manner thereof.

25. The mobile terminal apparatus according to claim 16, wherein a plurality of the registered pictographs and the colors and patterns corresponding thereto are arbitrarily set.

26. The mobile terminal apparatus according to claim 16, wherein the pictograph light driving means checks the content of the electronic mail and, every time that the pictograph registered in advance exists in the electronic mail, drives the pictograph light display portion in the color and pattern corresponding to the checked pictographs in a sequential manner thereof.
